(19) United States
(12) Patent Application Publication
(10) Pub. No.: US 2011/0119191 A1
(43) Pub. Date: May 19, 2011

(54) LICENSE OPTIMIZATION IN A VIRTUALIZED ENVIRONMENT

(75) Inventors: EDITH H. STERN, YORKTOWN HEIGHTS, NY (US); BARRY E. WILLNER, BRIARCLIFF MANOR, NY (US); DAVID E. REICH, JUPITER, FL (US); MARJORIE R. WILLNER, BRIARCLIFF MANOR, NY (US)

(73) Assignee: INTERNATIONAL BUSINESS MACHINES CORPORATION, ARMONK, NY (US)

(21) Appl. No.: 12/622,019

(22) Filed: Nov. 19, 2009

(51) Int. Cl. G06F 9/44; G06Q 10/00; G06Q 50/00; G06F 21/00

(52) U.S. Cl. 705/59; 718/1

(57) ABSTRACT

License optimization using a virtualized environment that includes receiving, by a processing device, a system requirement, analyzing, by the processing device, a use of a software component installed in a system in view of a license associated with the software component, and generating, by the processing device, an indication for placement of a virtualization of the software component to satisfy the system requirement responsive to the analysis. The optimization optimizing cost comprising at least a charge for the license.

### BACKGROUND

Aspects of the present invention relate to software licenses, and more specifically to license optimization in a virtualized environment.

Typically, software companies charge for their software based on multiple factors included in a license. Common factors may include the number of processors (or cores) the software can be run on, the power of the processor on which the software is to be run, and the operating system on which the software may run, etc. If the software is an operating system, then the processor and the power of the processor may apply. The criteria for acceptable use and charges for software are usually included in the license associated with the software.

Virtualization technologies allow a single server or processor to be divided into multiple, logical servers or processors. Subsystems such as Customer Information Control System (CICS) or Web Application Server (WAS) can run multiple different applications concurrently. Systems and applications can be stored as images and then instantiated in these virtual environments. Running systems can also be moved between environments without being shut down using technologies such as “Live Partition Mobility” from IBM or Vmotion® from VMware®.

### BRIEF SUMMARY

According to one aspect of the present invention, a method, operable on a processing device, for license optimization using a virtualized environment that includes receiving, by the processing device, a system requirement, analyzing, by the processing device, a use of a software component installed in a system in view of a license associated with the software component, and generating, by the processing device, an indication for placement of a virtualization of the software component to satisfy the system requirement responsive to the analysis that will optimize cost comprising at least a charge for the license.

According to another aspect of the present invention, a processing device for license optimization in a virtualized environment includes a network interface, the network interface being configured to receive a system requirement, and a processor, the processor configured to analyze a use of a software component installed in a system in view of a license associated with the software component, and generate an indication for placement of a virtualization of the software component to satisfy the system requirement responsive to the analysis that will optimize cost comprising at least a charge for the license.

According to a further aspect of the present invention, a computer program product comprising a computer readable storage medium having computer readable program code embodied therewith, the computer readable storage medium including computer readable program code configured to receive a system requirement, computer readable program code configured to analyze a use of a software component installed in a system in view of a license associated with the software component, and computer readable program code configured to generate an indication for placement of a virtualization of the software component to satisfy the system requirement responsive to the analysis that will optimize cost comprising at least a charge for the license.

### BRIEF DESCRIPTION OF THE SEVERAL VIEWS OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 shows a flowchart of a process for license optimization using a virtualized environment according to an exemplary embodiment of the present invention;

FIG. 2 shows a flowchart of a process for license optimization using a virtualized environment according to another exemplary embodiment of the present invention; and

FIG. 3 shows a flowchart of a process for license optimization using a virtualized environment according to a still further exemplary embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments according to the present invention provide an automated way to decide where to deploy software in shared environments to optimize a licensing cost of the software. Further, embodiments according to the present invention negotiate capacity requirements based in part on a licensing cost of software. In addition, embodiments according to the present invention match users looking to deploy software with entities that can provide a host and that can offer the host services at an optimized cost.

According to embodiments of the present invention, a processing device may receive a request for a system requirement, identify a software component related with the system requirement, identify criteria and a license associated with the software component, and provide a recommendation or an indication to the requester for instantiating a new virtual machine running the software component to meet the system requirement without requiring a new software license. The following example is being presented to help illustrate embodiments of the present invention.

Assume a user requests a database server running a database (e.g., Oracle® database) on a Linux® operating system, with a throughput requirement equivalent to 50 MIPS on a processor. A processing device executing a software application according to embodiments of the present invention may be managing virtual server placement in a data center containing a system mainframe computer. The software application may determine that a virtual machine running on a processor using 300 MIPS is running a database on Linux. The software application according to embodiments of the present invention, knows that the database on Linux on this particular processor can be expanded to 550 MIPS, the capacity of the processor without paying for an additional database license. The software application determines this based upon criteria in the license associated with the database software (e.g., the license defines the 550 MIPS maximum processor capacity for running the database). The software application may request the Linux operating system to instantiate another virtual machine of 50 MIPS running Linux on the mainframe and database on the same processor. The virtual machine may be instantiated and access to the database given to the requested user. Since the processor using 300 MIPS is running a database (e.g., Oracle® database) and a virtual machine is running the database using 50 MIPS, the license maximum of 550 MIPS has not been exceeded and no new license is required. An application/software license may specify one or more of a processor, a processor type, a core, a core type, a hyper thread, a hyper thread type, a server or a server type on which the software component is licensed to run.

To use another example to help illustrate embodiments according to the present invention, a user requests a system consisting of a Web Sphere Application Server (WAS) software and a Database 2 (DB2) application on Linux. The user's throughput requirement is equivalent to 300 MIPS of DB2 and 200 MIPS of WAS. A processing device executing a software application, according to embodiments of the present invention may be managing virtual server placement in a data center containing a system mainframe (e.g., a z9 EC mainframe). The software application may determine that two virtual machines running on a processor or core using 200 MIPS of DB2 and 300 MIPS of WAS respectively are running Linux on an operating system (e.g., zVM). The processing device executing the software application according to embodiments of the present invention, may install the operating system on an additional processor. The 200 MIP existing DB2 virtual machine may be moved to the new processor and a new 300 MIP DB2 virtual machine created. The processing device running the software application may leave the existing 300 MIP WAS virtual machine in place and create another 200 MIP WAS virtual machine. Therefore, no new DB2 or WAS licenses are required. An additional license for the operating system on the second processor may be required.

According to embodiments of the present invention, a processing device may receive an indication of a requirement for a system containing one or more software components, determine at least one software component installed in one or more systems, and provide an indication of the placement of a software component that will optimize cost at least one aspect being the license charge, responsive to one or more rules or policies related to software license charges associated with the software component. In some embodiments according to the present invention, the cost which is being optimized may consist of licensing alone. Moreover, according to embodiments of the present invention, costs may include any of many other items such as, for example, licensing costs, power costs, hardware costs, labor costs, etc. For example, if a user requests a system consisting of WAS and DB2 on Linux, his throughput requirement may be equivalent to 300 MIPS of DB2 and 300 MIPS of WAS. A processing device, according to embodiments of the present invention, may include a software application managing virtual server placement in a data center containing a system mainframe. The software application may determine that two virtual machines running on a processor using 200 MIPS of DB2 and 300 MIPS of WAS respectively are running Linux on an operating system. Unfortunately, the WAS may be used by an existing application. The processing device executing the software application, according to embodiments of the present invention, may examine the cost of breaking the service level agreement (SLA), determine that it is less than the cost of additional WAS licenses, run the existing virtual machine with WAS at lower priority and enable a new placement of the software. Therefore, overall cost has been optimized.

In addition, embodiments according to the present invention may determine and provide an alternate requirement for a requested system. In addition, embodiments according to the present invention may provide information regarding a performance of an indicated software placement and original indicated requirement. The performance may be a projected performance or an actual measured performance determined after implementation of the indicated software placement. To help illustrate, assume a user requests a database server running a database (e.g., an Oracle database) in Linux with a throughput requirement equivalent to 300 MIPS on a processor (e.g., IFL processor). A processing device executing a software application according to the embodiments of the present invention may be managing virtual server placement in a data center containing a system mainframe (e.g., z9 EC). The software application running on the processing device may determine that a virtual machine running on the processor using 300 MIPS is running an Oracle database on Linux. The software application may know that an Oracle database on Linux on this processor can be expanded to 550 MIPS, the capacity of the processor, without paying for an additional license. The software application running on the processing device may then provide an indication to the requester that a virtual machine of 250 MIPS may be provided at very effective licensing terms and may be less expensive. The requester may be prompted to respond whether this is acceptable or not. The requester/user may query the processing device (e.g., server) running the software application to require if processing greater than 250 MIPS may be occasionally accessed. The processing device running the software application may analyze a performance profile of the first virtual machine which has a commitment for 300 MIPS and determine that it exceeds 250 MIPS only 3% of the time. The processing device running the software application may then provide an indication to the requester such as, for example, “over the last month it would have been possible to access a full 300 MIPS 97% of the time”. The user/requester may send an acceptance to the processing device accepting a commitment of 250 MIPS with the outlook to get more. The virtual machine may then be instantiated and access to the database given to the requester/user. Although in this example, interaction exists between the processing device running the software application and the requester/user, other embodiments according to the present invention may be performed automatically without any requester/user input.

According to embodiments of the present invention, a processing device executing a software application may determine at least one licensed software component in a system, determine at least one processor on which the software component is licensed to run, determine some aspect of utilization of a processor on which the software component is licensed to run, determine some aspect of capacity of a new virtual machine running the software component that might be run on the processor, and communicate some aspect of capacity of a new virtual machine running the software component that might be run on the processor. To help illustrate, assume an enterprise is looking to maximize the IT services it provides. A processing device executing a software application according to embodiments of the present invention may search for additional software capacity that can be made available without purchasing extra licenses. For example, discovering what software is installed, comparing fully installed software to licensing terms and conditions associated with the installed software, and determining additional available capacity. The enterprise or business may desire to make use of their unused software license capacity and may plan to use virtualization technology to partition the excess space such that it can be sold. The partition may insure that there is no communication or interaction between the company's current software usage and the to-be-sold and used capacity. A known concept of dynamic provisioning software allows unused capacity to be tied together, for example, the extra capacity of WAS and DB2 may be bundled together optimizing the overall usage of the excess capacity. The enterprise or company owns the software licenses and the hardware can optimize the CPU usage during what may be downtime to get business benefit from it by selling the excess capacity for use by another. This solution minimizes energy, floor space, hardware usage, and therefore, allows maximization of equipment during low peak times.

Therefore, a processing device according to exemplary embodiments of the present invention, may receive an indication of a requirement for a system containing one or more software components, determine one or more software components installed on a system, using at least one rule or policy related to a software license charge of the software component, and provide an indication or suggestion of the placement of a software component that will optimize the license charge. The receiving of an indication of a requirement for a system containing one or more software components may be accomplished from a spectrum of approaches. For example, a system architect may explicitly specify the software components required and the capacity needed. This may occur by inputting this information in a table or using a graphical tool in which the system topology can be laid out and the capacity stated. Further, this may be accomplished in a highly automated way where the system description is given in business terms and then programmatically or semi-programmatically turned into system requirements. Tools such as WebSphere Business Modeler may be used to see how various system configurations can meet business requirements.

Regarding determining one or more software components to install in a system, an inventory of software components installed in the system may be made either through manual entry or by auto discovery by using tools such as, for example, IBM Tivoli Application Dependency Discovery Manager (TADDM). The inventory may be stored in a database such as, for example, IBM Tivoli Change and Configuration Management Database (CCMDB). This determination can be made by querying the data in the CCMDB.

Regarding using at least one rule or policy related to a software license charge related to the license charge of the software component, rules may be explicitly entered into a rules engine such as, for example, IBM Web Sphere Business Rules. A rule may include, for example, “there is a fixed license charge for all virtual machines running this software component on the same core”. The rules engine optionally can make the determination of where to place the component. Regarding giving an indication of the placement of software components that will optimize the licensing charge, this indication may be through a web page to a user, a report, or programmatically linked to a dynamic provision system such as, for example, IBM Tivoli Intelligent Orchestrator to install the software component.

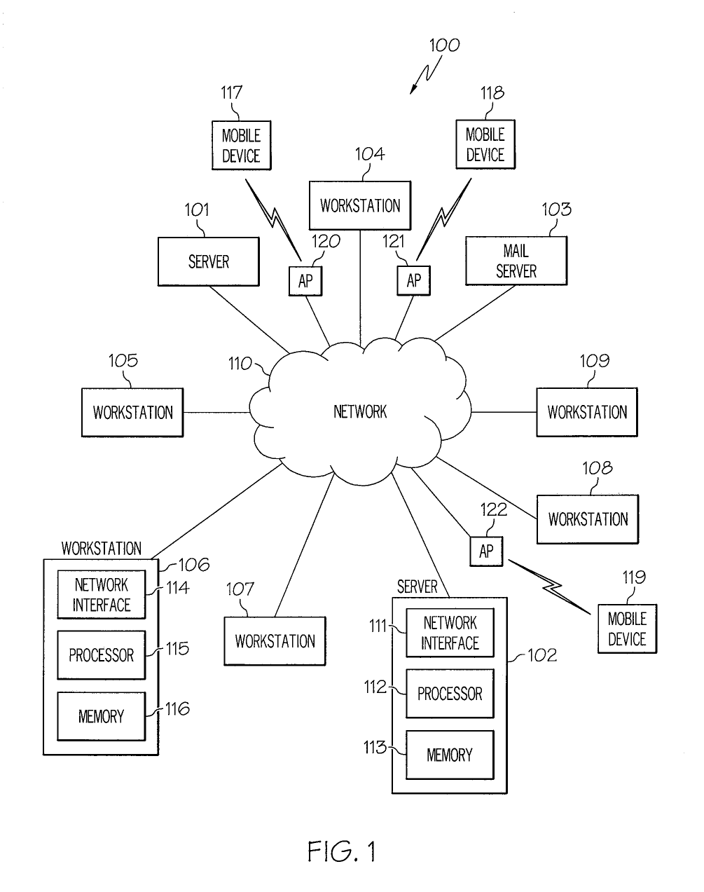

FIG. 1 shows a diagram of a system for license optimization using a virtualized environment according to an exemplary embodiment of the present invention. A system 100 may include one or more servers 101, 102, one or more mail servers 103, one or more wireless devices 117-119, and one or more workstations 104-109, where the servers 101, 102, wireless devices 117-119, and workstations 104-109 may be interconnected via a network 110. The wireless devices 117-119 may access the network 110 via one or more access points 120-122 or by any other method. The wireless devices 117-119 may be any type of wireless device such as, for example, a mobile phone, a personal digital assistant (PDA), a portable game system, a laptop computer, etc. The network 110 may be the Internet, an intranet, a local area network, a wide area network, or any other type of network. Each server 101, 102, 103 may include a network interface 111, a processor 112, a memory 113, and other elements normally associated with a server. Similarly, each workstation 104-109 may include a network interface 114, a processor 115, and memory 116, and other items normally associated with a workstation. A processor 112 of each server 101, 102, 103 or a processor 115 of each workstation 104-109 may execute software and/or be configured to determine a license optimization using a virtualized environment.

A network interface 111 of each server 101, 102, 103 or a network interface 114 of each workstation 104-109 may be configured to receive a system requirement. A processor 112 of each server 101, 102, 103 or a processor 115 of each workstation 104-109 may be configured to analyze a use of a software component installed in a system in view of a license associated with the software component, and generate an indication for placement of at least one virtualization of the software component to satisfy the system requirement responsive to the analysis that will optimize cost comprising at least a charge for the license. A processor 112 of each server 101, 102, 103 or a processor 115 of each workstation 104-109 may be configured to identify a capacity used by the software component installed in the system, compare the capacity with capacity information in the license, and determine additional available capacity based on the comparison. The license may specify one or more processors on which the software component is licensed to run. The virtualization may include a virtualized processor running the software component. The optimization may include allowing use of the software component and the virtualized software component without requiring an additional license and associated cost for the license. A processor 112 of each server 101, 102, 103 or a processor 115 of each workstation 104-109 may also be configured to analyze the system after placement of one or more virtualizations of the software component and provide an indication for a placement of a second one or more virtualizations of the software component to satisfy the system requirement. A processor 112 of each server 101, 102, 103 or a processor 115 of each workstation 104-109 may further be configured to provide information of a of the system with the placement of the second one or more virtualizations of the software component. A measured performance may be presented in comparison with the requested system requirement.

Moreover, according to embodiments of the present invention, a processor 112 of each server 101, 102, 103 or a processor 115 of each workstation 104-109 may be configured to determine utilization information of a processor on which the software component is licensed to run. A processor 112 of each server 101, 102, 103 or a processor 115 of each workstation 104-109 may also be configured to determine a capacity of a new virtualized processor running the software component. The capacity of the new virtualized processor may include at least one of a throughput capacity, a storage capacity and a performance capacity. The cost may include at least one of a power usage cost, a hardware cost and a labor cost.

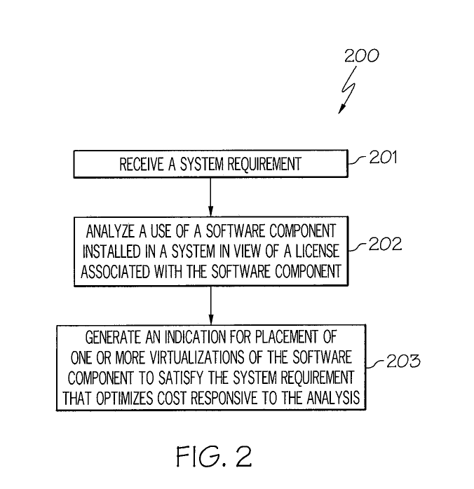

FIG. 2 shows a flowchart of a process for license optimization using a virtualized environment according to an exemplary embodiment of the present invention. In the process 200, in block 201, a system requirement may be received. In block 202, a use of a software component installed in a system may be analyzed in view of a license associated with the software component. In block 203, an indication for placement of one or more virtualizations of the software component may be generated that satisfy the system requirement and that optimizes costs responsive to the analysis.

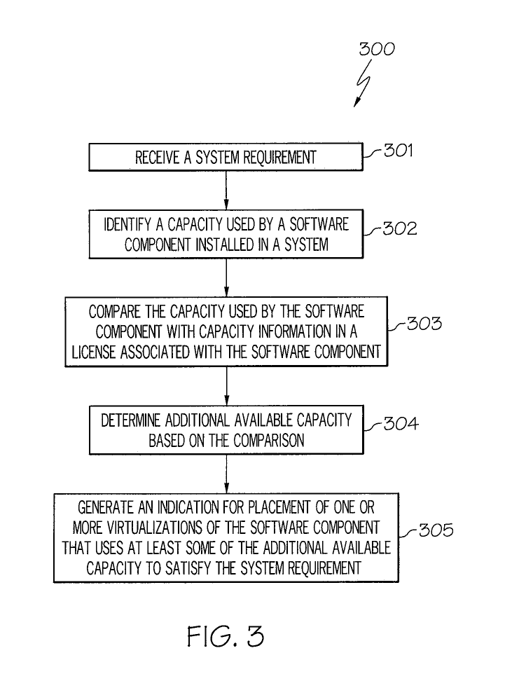

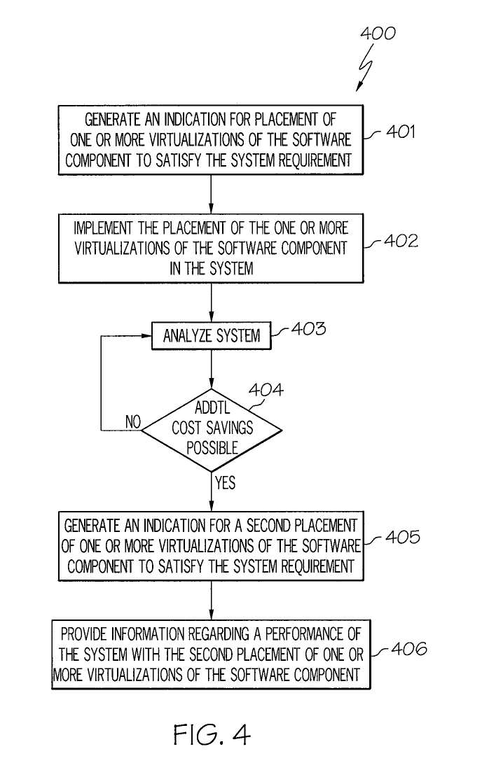

FIG. 3 shows a flowchart of a process for license optimization using a virtualized environment according to another exemplary embodiment of the present invention. In the process 300, in block 301, a system requirement may be received. In block 302, a capacity used by a software component installed in a system may be identified. In block 303, the capacity used by the software component may be compared with capacity information in a license associated with the software component. In block 304, additional available capacity may be determined based on the comparison. In block 305, an indication for placement of one or more virtualizations of the software component that uses at least some of the additional available capacity may be generated to satisfy the system requirement.

FIG. 4 shows a flowchart of a process for license optimization using a virtualized environment according to a still further exemplary embodiment of the present invention. In the process 400, in block 401, an indication for placement of one or more virtualizations of a software component to satisfy the system requirement may be generated. In block 402, the placement of the one or more virtualizations of the software component may be implemented in the system. In block 403, the system may be analyzed. In block 404, it may be determined if there are additional costs savings possible and if not, the process returns to block 403 where the system is analyzed. If additional cost savings are possible, then in block 405, an indication for a second placement of one or more virtualizations of the software component to satisfy the system requirement may be generated. In block 406, information regarding a performance of the system with the second placement of the one or more virtualizations of the software component may be provided. The performance may be presented compared with the system requirement.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention has other applications in other environments. This application is intended to cover any adaptations or variations of the present invention. The following claims are in no way intended to limit the scope of embodiments of the invention to the specific embodiments described herein.

What is claimed is:

1. A method, operable on a processing device, for license optimization using a virtualized environment comprising:
receiving, by the processing device, a system requirement;
analyzing, by the processing device, a use of a software component installed in a system in view of a license associated with the software component; and
generating, by the processing device, an indication for placement of a virtualization of the software component to satisfy the system requirement responsive to the analysis.

2. The method according to claim 1, wherein analyzing, by the processing device, a use of a software component installed in a system in view of a license associated with the software component further comprises the processing device identifying a capacity used by the software component installed in the system, comparing the capacity with capacity information in the license, and determining additional available capacity based on the comparison.

3. The method according to claim 1, wherein the license specifies at least one processor, processor type, core, core type, hyper thread, hyper thread type, server and server type on which the software component is licensed to run.

4. The method according to claim 1, further comprising the processing device analyzing the system after placement of the virtualization of the software component and providing an indication for a placement of a second virtualization of the software component to satisfy the system requirement.

5. The method according to claim 4, further comprising the processing device providing information of a performance of the system with the placement of the second virtualization of the software component.

6. The method according to claim 1, wherein the virtualization comprises a virtualized processor running the software component.

7. The method according to claim 1, wherein the placement of the virtualization of the software component to satisfy the system requirement responsive to the analysis optimizes use of the license, the optimization comprising at least allowing use of the software component and the virtualized software component without requiring an additional license and associated charge for the license, the optimization optimizing cost comprising at least a charge for the license.

8. The method according to claim 7, wherein the cost further comprises at least one of a power usage cost, a hardware cost and a labor cost.

9. The method according to claim 1, further comprising providing by the processing device performance information of the indicated placement of the virtualization of the software component compared with a performance associated with the received system requirement, the performance information being related to one of a projected performance and a measured performance after the indicated placement.

10. The method according to claim 1, further comprising the processing device determining utilization information of a processor on which the software component is licensed to run.

11. The method according to claim 1, further comprising the processing device determining a capacity of a new virtualized processor running the software component.

12. The method according to claim 11, further comprising the processing device communicating the capacity of the new virtualized processor running the software component.

13. The method according to claim 11, wherein the capacity of the new virtualized processor comprises one of a throughput capacity, a storage capacity and a performance capacity.

14. A processing device for license optimization in a virtualized environment comprising:
a network interface, the network interface being configured to receive a system requirement; and
a processor, the processor configured to analyze a use of a software component installed in a system in view of a license associated with the software component, and generate an indication for placement of a virtualization of the software component to satisfy the system requirement responsive to the analysis.

15. The processing device according to claim 14, wherein the processor configured to analyze a use of a software component installed in a system in view of a license associated with the software component further comprises the processor configured to identify a capacity used by the software component installed in the system, compare the capacity with capacity information in the license, and determine additional available capacity based on the comparison.

16. The processing device according to claim 14, wherein the license specifies at least one processor, processor type, core, core type, hyper thread, hyper thread type, server and server type on which the software component is licensed to run.

17. The processing device according to claim 14, wherein the virtualization comprises a virtualized processor running the software component.

18. The processing device according to claim 14, wherein the placement of the virtualization of the software component to satisfy the system requirement responsive to the analysis optimizes use of the license, the optimization comprising at least allowing use of the software component and the virtualized software component without requiring an additional license and associated cost for the license, the optimization optimizing cost comprising at least a charge for the license.

19. A computer program product comprising a computer readable storage medium having computer readable program code embodied therewith, the computer readable storage medium comprising:
computer readable program code configured to receive a system requirement;
computer readable program code configured to analyze a use of a software component installed in a system in view of a license associated with the software component; and
computer readable program code configured to generate an indication for placement of a virtualization of the software component to satisfy the system requirement responsive to the analysis.

20. The computer program product according to claim 19, wherein the computer readable program code configured to analyze a use of a software component installed in a system in view of a license associated with the software component further comprises computer readable program code configured to analyze further comprises identifying a capacity used by the software component installed in the system, computer readable program code configured to compare the capacity with capacity information in the license, and computer readable program code configured to determine additional available capacity based on the comparison.
